(19) United States
(12) Patent Application Publication
(10) Pub. No.: US 2024/0243628 A1
(43) Pub. Date: Jul. 18, 2024

(54) MOLDED ROTOR ENDCAPS

(71) Applicant: FORD GLOBAL TECHNOLOGIES, LLC, Dearborn, MI (US)

(72) Inventors: Devan James Anderson, Taylor, MI (US); Matthew Schmitt, Southgate, MI (US)

(21) Appl. No.: 18/153,826

(22) Filed: Jan. 12, 2023

(51) Int. Cl. H02K 1/28; H02K 1/276; H02K 1/32

(52) U.S. Cl. CPC H02K 1/28; H02K 1/276; H02K 1/32

(57) ABSTRACT

A rotor assembly includes a plurality of laminations stacked to form a rotor core that defines a plurality of pockets and coolant passageways, a plurality of magnets disposed within the pockets, and a molded cage. The molded cage includes a plurality of columns securing the magnets within the pockets, and a pair of endcaps covering portions of the pockets on opposite ends of the rotor core such that the endcaps are connected with the columns. The endcaps define a plurality of apertures in fluid communication with the coolant passageways.

### BACKGROUND

End plates can be on either side of a rotor core and be used to perform different functions. These functions include structural support, balance, and cooling distribution. Typically, end plates are made from aluminum and constitute two separate components in the rotor assembly.

### SUMMARY

In one example, a rotor assembly includes a plurality of laminations, a plurality of magnets, and resin. The laminations are stacked to form a rotor core. The rotor core defines a plurality of pockets and coolant passageways. The magnets are disposed within the pockets. The resin fills cavities defined by the pockets and magnets to secure the magnets within the rotor core, and extends out of some of the pockets and away from opposite ends of the rotor core to form endcaps that cover portions of the ends and define apertures in fluid communication with the coolant passageways such that the resin forms a continuous cylindrical cage extending through the rotor core.

In another example, a rotor assembly includes a rotor core and a resin cage. The resin cage includes endcaps in contact with opposite ends of, and sandwiching, the rotor core, and a plurality of columns extending through pockets of the rotor core and connected with the endcaps.

In yet another example, a rotor assembly includes a plurality of laminations, a plurality of magnets, and a molded cage. The laminations are stacked to form a rotor core that defines a plurality of pockets and coolant passageways. The magnets are disposed within the pockets. The molded cage includes a plurality of columns securing the magnets within the pockets, and a pair of endcaps covering portions of the pockets on opposite ends of the rotor core such that the endcaps are connected with the columns. The endcaps define a plurality of apertures in fluid communication with the coolant passageways.

### BRIEF DESCRIPTION OF THE DRAWINGS

FIG. 1 is block diagram of a vehicle.

FIG. 2 is perspective view of a rotor assembly.

FIG. 3A is a side view, in cross-section, of the rotor assembly of FIG. 2 shown within the environment of the electric machine of FIG. 1.

FIG. 3B is another side view, in cross-section, of the rotor assembly of FIG. 2 shown within the environment of the electric machine of FIG. 1.

FIG. 4 is a schematic perspective view of portions of the rotor assembly of FIG. 2.

FIGS. 5 and 6 are schematic perspective views of portions of alternative rotor assemblies.

### DETAILED DESCRIPTION

Embodiments are described herein. It is to be understood, however, that the disclosed embodiments are merely examples and other embodiments may take various and alternative forms. The figures are not necessarily to scale. Some features could be exaggerated or minimized to show details of particular components. Therefore, specific structural and functional details disclosed herein are not to be interpreted as limiting, but merely as a representative basis for teaching one skilled in the art.

Various features illustrated and described with reference to any one of the figures may be combined with features illustrated in one or more other figures to produce embodiments that are not explicitly illustrated or described. The combinations of features illustrated provide representative embodiments for typical applications. Various combinations and modifications of the features consistent with the teachings of this disclosure, however, could be desired for particular applications or implementations.

Rotor end plates of an electric machine are contemplated that are created during the resin molding process. Some manufacturing processes may fix magnets within magnet pockets of the rotor core by injecting resin compound into the rotor core. By creating a housing and integrated mold for the rotor core with cavities on either side, the cavities can be filled to create resin endplates. These resin endplates can serve the same functions of cooling fluid distribution and structural support as traditional endplates. Before discussing this in further detail, a brief overview of a vehicle including an electric machine is provided.

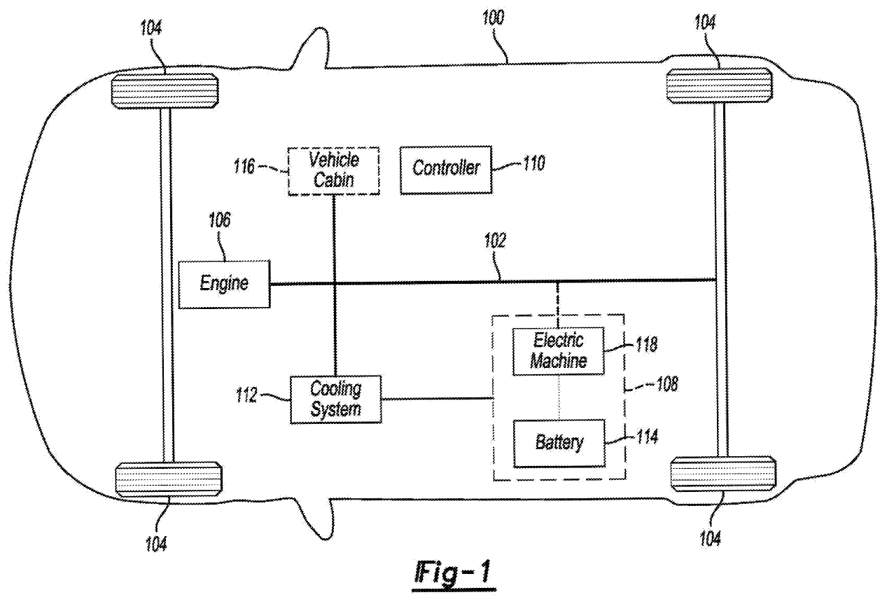

Referring to FIG. 1, a vehicle 100 may include a drivetrain 102. The drivetrain 102 may be configured to propel one or more wheels 104. The drivetrain 102 may be in at least one of electrical, magnetic, and mechanical communication with at least one of an internal combustion engine 106 and a power arrangement 108. As such, the drivetrain 102 may be configured to facilitate power transfer between one of the engine 106 and power arrangement 108, and the wheels 104. In some embodiments, the drivetrain 102 may be configured for fluid communication with the engine 106. For example, the drivetrain 102 may include a torque converter for fluid interaction between the drivetrain 102 and engine 106. Alternatively, the vehicle 100 may include a clutch for mechanical interaction between the drivetrain 102 and engine 106. Further, the drivetrain 102 may be configured for at least one of electrical and magnetic interaction with the power arrangement 108.

The engine 106 may be used to provide torque to a propulsion system within the vehicle 100. The engine 106 may convert chemical energy from a fuel source into mechanical energy. In particular, the engine 106 may provide mechanical energy in the form of rotational energy exerted upon a crankshaft. The engine 106 may be configured to provide the mechanical energy to a transmission through the crankshaft. The engine 106 may be in communication with a controller 110, and include a plurality of sensors. One of the sensors may determine and provide engine parameters to the controller 110, such as engine speed, fuel economy, lubricant level, or other engine parameters.

The vehicle 100 may include a cooling system 112 configured to regulate temperature of various power sources within the vehicle 100. In one embodiment, the cooling system 112 may be in thermal communication with a battery 114 of the power arrangement 108. The cooling system 112 may be configured to regulate a temperature of the battery 114. The cooling system 112 may be configured to provide coolant to the battery 114 and be in thermal communication with a cabin 116 of the vehicle 100. In some embodiments, the cooling system 112 may be in thermal communication with the cabin 116 via fluid communication, and/or be configured to reheat the cabin 116. The cooling system 112 may also be configured to regulate a temperature of an electric machine 118 of the power arrangement 108 by delivering coolant thereto.

The controller 110 may include a memory system and processor. The memory system may be configured to store instruction sets such as programs, algorithms, methods, etc. The memory system may be further configured to receive, monitor, and store values presented to the controller 110. Further, the memory may serve as a database. As such, the memory may create, store, and edit data stored in the database. The database may define a schedule. Alternatively, or additionally, the database may define a plurality of schedules. A schedule may include entries used as reference for operating a device. The processor may be configured to execute instruction sets. The controller 110 may be configured to receive signals indicative of information from external sources including but not limited to sensors, devices, and other controllers. The controller 110 may be configured to receive information by various ways including electrical communication and electrical-magnetic communication. Further, the vehicle 100 may include a plurality of controllers.

The power arrangement 108 may be configured to facilitate electrical communication between power electronics within the vehicle 100, and may use a plurality of electrical bus networks to facilitate the communication. One of the electrical bus networks may be a high-voltage bus network. The high-voltage bus network may be configured to provide DC electricity to electrical components requiring a high voltage. For example, the high-voltage bus network may be configured to have an electrical potential difference of 500 volts. The high-voltage bus network may be configured to be in direct electrical communication with the battery 114. Another of the electrical bus networks may be a low-voltage bus network. The low-voltage bus network may be configured to provide DC electricity to electrical components requiring a low voltage. For example, the low-voltage bus network may be configured to have an electrical potential difference of 12 volts. The low-voltage bus network may be in direct electrical communication with an auxiliary battery.

The power arrangement 108 may have a converter. The converter may be configured to convert electricity having a first set of electrical parameters into a second set of electrical parameters. For example, the converter may be configured to convert electricity at 500 volts into electricity at 12 volts. The power arrangement 108 may include a common ground. The ground may be configured to act as a source of low electrical potential to facilitate the flow of electrical current. In some embodiments, the high-voltage bus network shares a common ground with the low-voltage bus network. Alternatively, the power arrangement 108 may have a plurality of electrical grounds.

The battery 114 may be used to provide energy to a propulsion system of the vehicle 100, and store energy from the propulsion system. The battery 114 may include a plurality of battery cells. In some embodiments, at least two of the battery cells are in series. Alternatively or additionally, at least two of the battery cells are in parallel. The battery 114 may have a plurality of sensors. One of the sensors may determine and provide battery parameters to the controller 110.

The electric machine 118 is configured to covert power between electrical and mechanical components. The electric machine 118 may act as a motor, converting electrical energy into mechanical energy. For example, the electric machine 118 may be configured to convert electrical energy from the battery 114 into mechanical energy for driving the drivetrain 102. Alternatively, the electric machine 118 may be configured to receive electrical energy from an electrical bus network. As such, the electric machine 118 may be configured to receive electrical energy from other vehicle components configured to provide electrical energy to the electrical bus network.

The electric machine 118 may act as generator 116, converting mechanical energy into electrical energy. For example, the electric machine 118 may be configured to convert mechanical energy from the engine 106 into electrical energy for charging the battery 114. The electric machine 118 may also be used to convert mechanical energy from the engine 106 into electrical energy for powering a vehicle load.

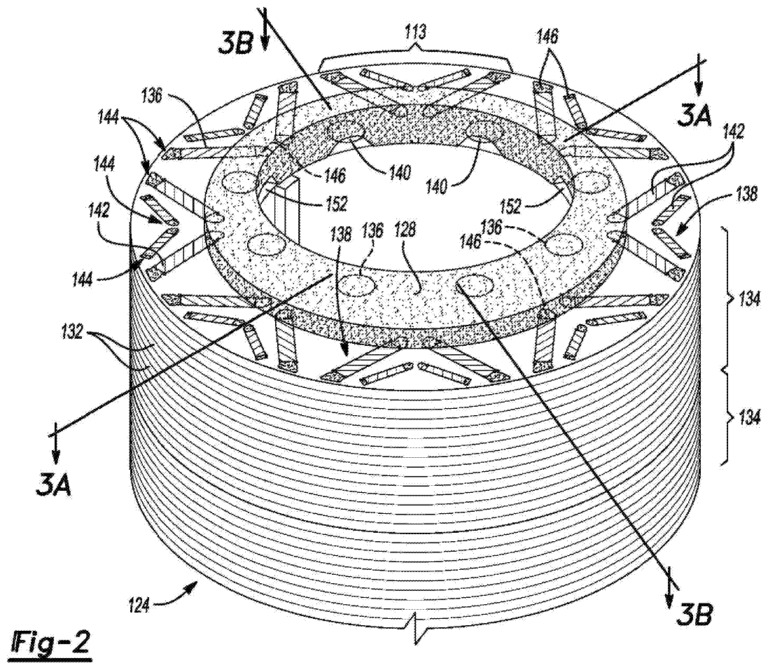

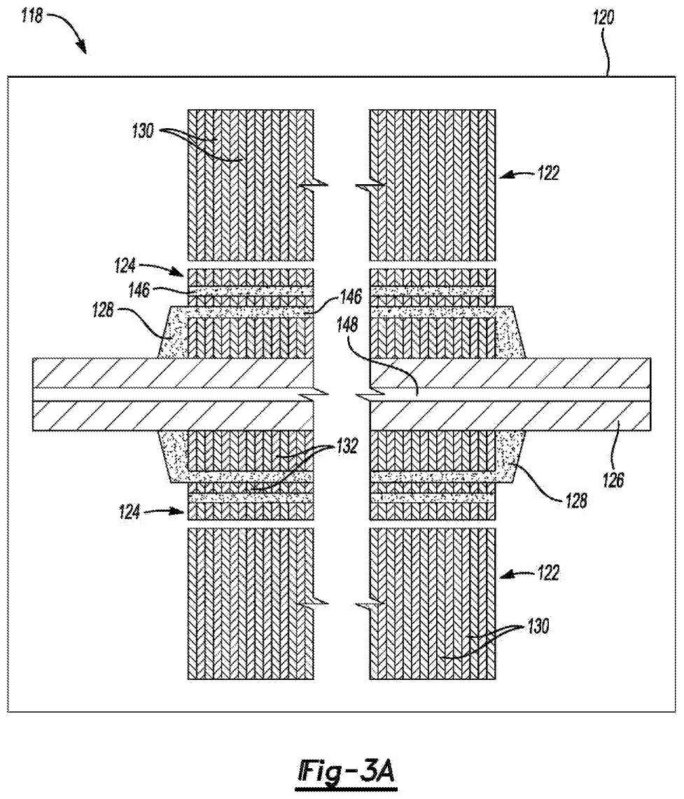

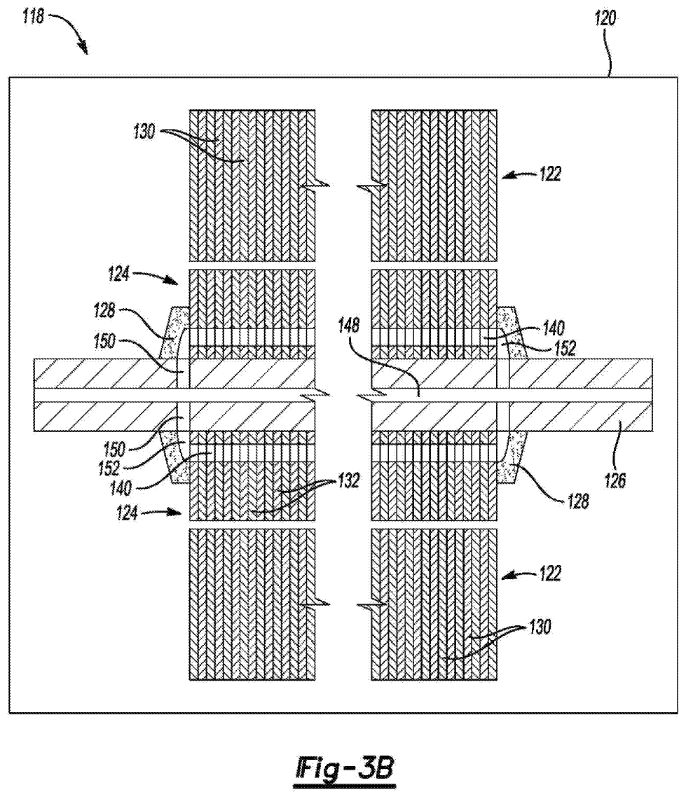

Referring to FIGS. 2, 3A, and 3B, the electric machine 118 includes a housing 120. The housing 120 is configured to encase and support a stator 122, rotor 124, shaft 126, and end plates 128. The housing 120 is further configured to contain a cooling fluid delivered from the cooling system 112. The cooling fluid transfers heat from the electric machine 118 to the cooling system 112, where it can be dissipated via known techniques. The housing 120 is configured to support the stator 122 such that it is spaced apart from the rotor 124 as known in the art.

The stator 122 includes a plurality of stacked stator laminations 130. In some embodiments, the stator laminations 130 may be composed of a material configured to increase conversion efficiency. For example, the stator laminations 130 may be composed of an iron alloy.

The rotor 124 likewise includes a plurality of stacked laminations 132 defining a core. In some embodiments, a grouping of the laminations 132 may define a layer 134. The rotor 124, in this embodiment, includes a plurality of the layers 134. Each of the laminations 132 may define a plurality of openings 136. The laminations 132 of each of the layers 134 are aligned such that their openings 136 are in registration with each other to define pockets 138 and fluid passageways 142. Corresponding pockets and fluid passageways of each of the layers 134 in this embodiment are in registration with each other. Although in other embodiments, each of the layers 134 may be rotated or clocked relative to an adjacent one of the layers 134 such that the corresponding pockets overlap but are not in registration with each other. The pockets 138, in this embodiment, are arranged in V-shaped pairs. Other arrangements, however, are also contemplated. The pockets 138 are configured to hold one or more magnets 142 (e.g., permanent magnets) therein. The pockets are longer than the magnets 142 such that ends of the magnets 142 and corresponding pockets define cavities 144 on each side of the magnets 138. The cavities 144 may be filled with a resin 146 (or similar material) to mechanically hold the magnets 142 in place. As discussed in further detail below, some of the resin 146 may extend away from the ends of the rotor 124 to form the endplates 128.

The shaft 126 extends through the rotor 124 and endplates 128, and is mechanically engaged therewith such that the rotor 124, shaft 126, and endplates 128 rotate together. The shaft 126 defines a fluid channel 148 therethrough that is in fluid communication with the cooling system 112. The shaft 126 also defines access channels 150 that extend radially away from the fluid channel 148 and towards the end plates 128. The access channels 150 are aligned with vias (apertures) 152 in the endplates 128. This permits the flow of coolant from the fluid channel 148 to the fluid passageways 140 as directed by the vias 152. The rotor shaft may be composed of a ferro-magnetic material. For example, the rotor shaft may be composed of iron, an iron derivative, neodymium, etc.

The endcaps 128 partially cover opposite ends of the rotor 124. As mentioned above, the endcaps 128 are formed from the resin 146. That is, they can be created during the resin molding process. The magnets 142 are fixed within the pockets 138 by injecting resin compound into the cavities 144. An integrated mold for the rotor 124 with the complement of forms for the endcaps 128 on each side of the rotor 124 could also be injected with the resin compound. Because the endcaps 128 overlap with some of the cavities 144, the resin 146 filling the some of the cavities 144 and the resin 146 of the endcaps 128 form a continuous cage-like structure. While the resin 146 has a greater magnetic reluctance than other materials such as iron, the resin lowers the mass of the endcaps 128 as compared with metal. Lowering the mass of the endcaps 128 may increase performance attributes of the electric machine 118. The endcaps 128 may be used to support, balance, and distribute cooling throughout the rotor 124. The endcaps 128 as mentioned above include the vias 152, which in this embodiment are evenly spaced around the endcaps 128 to correspond with the fluid passageways 140.

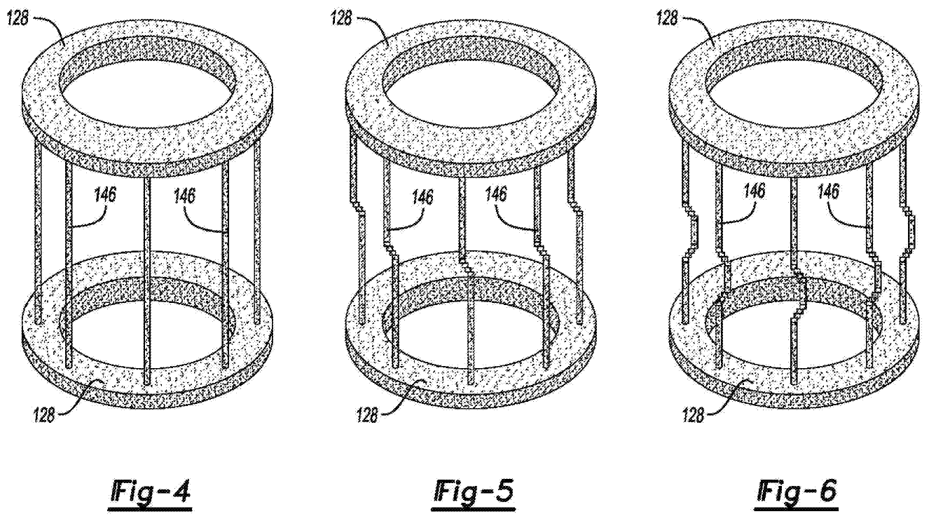

Referring to FIG. 4, the endcaps 128 and resin 146 filling some of the cavities 144 covered by the endcaps 128 form a continuous cage-like structure as mentioned above. Here, the resin 146 filling some of the cavities 144 takes the form of pillars or columns extending between the endcaps 128 and through the rotor.

Referring to FIGS. 5 and 6, the pillars may have a stepped or zig-zag like shape when the laminations 132 or layers 134 are clocked relative to each other as described above.

While exemplary embodiments are described above, it is not intended that these embodiments describe all possible forms encompassed by the claims. The words used in the specification are words of description rather than limitation, and it is understood that various changes may be made without departing from the spirit and scope of these disclosed materials. The words controller and controllers, and variations thereof for example, may be interchanged.

As previously described, the features of various embodiments may be combined to form further embodiments of the invention that may not be explicitly described or illustrated. While various embodiments could have been described as providing advantages or being preferred over other embodiments or prior art implementations with respect to one or more desired characteristics, those of ordinary skill in the art recognize that one or more features or characteristics may be compromised to achieve desired overall system attributes, which depend on the specific application and implementation. These attributes may include, but are not limited to strength, durability, marketability, appearance, packaging, size, serviceability, weight, manufacturability, ease of assembly, etc. As such, embodiments described as less desirable than other embodiments or prior art implementations with respect to one or more characteristics are not outside the scope of the disclosure and may be desirable for particular applications.

What is claimed is:

1. A rotor assembly comprising:
a plurality of laminations stacked to form a rotor core that defines a plurality of pockets and coolant passageways;
a plurality of magnets disposed within the pockets; and
resin filling cavities defined by the pockets and magnets to secure the magnets within the rotor core, and extending out of some of the pockets and away from opposite ends of the rotor core to form endcaps that cover portions of the opposite ends and define apertures in fluid communication with the coolant passageways such that the resin forms a continuous cylindrical cage extending through the rotor core.

2. The rotor assembly of claim 1, wherein the resin filling the cavities forms columns extending between and connected with the endcaps.

3. The rotor assembly of claim 2, wherein the columns are perpendicular to the endcaps.

4. The rotor assembly of claim 1, wherein the laminations are arranged in layers rotated relative to one another such that the pockets of the layers overlap but are not aligned.

5. The rotor assembly of claim 4, wherein the resin filling the cavities forms stair-step columns extending between and connected with the endcaps.

6. The rotor assembly of claim 4, wherein the resin filling the cavities forms zig-zag columns extending between and connected with the endcaps.

7. A rotor assembly comprising:
a rotor core; and
a resin cage including endcaps in contact with opposite ends of, and sandwiching, the rotor core, and a plurality of columns extending through pockets of the rotor core and connected with the endcaps.

8. The rotor assembly of claim 7, wherein the rotor core includes a plurality of magnets disposed within the pockets such that the columns secure the magnets within the rotor core.

9. The rotor assembly of claim 7, wherein the rotor core defines a plurality of coolant passageways and wherein the endcaps define a plurality of apertures in fluid communication with the coolant passageways.

10. The rotor assembly of claim 7, wherein the endcaps cover portions of the pockets adjacent to the endcaps.

11. The rotor assembly of claim 7, wherein the columns have a stair-step configuration.

12. The rotor assembly of claim 7, wherein the columns have a zig-zag configuration.

13. A rotor assembly comprising:
a plurality of laminations stacked to form a rotor core that defines a plurality of pockets and coolant passageways;
a plurality of magnets disposed within the pockets; and
a molded cage including a plurality of columns securing the magnets within the pockets, and a pair of endcaps covering portions of the pockets on opposite ends of the rotor core such that the endcaps are connected with the columns, wherein the endcaps define a plurality of apertures in fluid communication with the coolant passageways.

14. The rotor assembly of claim 13, wherein the columns are perpendicular to the endcaps.

15. The rotor assembly of claim 13, wherein the columns have a stair-step configuration.

16. The rotor assembly of claim 13, wherein the columns have a zig-zag configuration.

17. The rotor assembly of claim 13, wherein the molded cage includes resin.

18. The rotor assembly of claim 13, wherein the rotor core is disposed within an electric machine.

19. The rotor assembly of claim 18, wherein the electric machine is a motor.

20. The rotor assembly of claim 19, wherein the motor is disposed within a vehicle.
